(19) United States
(12) Patent Application Publication
(10) Pub. No.: US 2026/0246211 A1
(43) Pub. Date: Aug. 20, 2026

(54) Electrical Connection Element

(71) Applicant: Bayerische Motoren Werke Aktiengesellschaft, Muenchen (DE)

(72) Inventor: Florian BIERWIRTH, Steinhoering (DE)

(21) Appl. No.: 18/879,025

(22) PCT Filed: Jun. 28, 2023
(86) PCT No.: PCT/EP2023/067554

§ 371 Date: Dec. 26, 2024

(30) Foreign Application Priority Data
Aug. 29, 2022 (DE) 10 2022 121 726.4

(51) Int. Cl. H01R 13/66; H01R 13/03; H01R 13/04; H01R 24/68; H01R 103/00

(52) U.S. Cl. CPC H01R 13/6691; H01R 13/03; H01R 13/04; H01R 13/6683; H01R 24/68; H01R 2103/00; H01R 2201/26

(57) ABSTRACT

An electrical connection element in a vehicle has a first electrical contact and a second electrical contact, which are connected in an electrically conductive manner within a connection housing of the electrical connection element. The connection housing has a housing component that is thermally coupled to the first electrical contact and the second electrical contact and includes an indicator element made of an irreversibly thermochromic material. The housing component is arranged such that the indicator element is not visible in a use state of the electrical connection element, and is visible in a maintenance state of the electrical connection element.

### BACKGROUND AND SUMMARY

The invention relates to an electrical connection element in a vehicle.

Interruptions of electrical connections of the respective vehicle represent one of the most frequent causes of failure in the automotive sector, which can be caused, for example, by degradation effects of the components participating in the electrical connection system. Such degradation effects are influenced by environmental influences occurring in driving operation, such as vibrations, temperature, moisture, and/or dirt development. It is therefore necessary to protect electrical connection systems from the effects of degradation mechanisms. This is of decisive importance in particular for automated driving in order to be able to ensure the high level of availability of the electrical connection system. Moreover, it is desirable to be able to protect imminent failures before they occur in order to be able to replace affected components in a timely manner.

Providing electrical contacts of connection systems with a protective coating and/or counteracting degradation mechanisms by means of design approaches is known, for example, by using clips or damping grommets. It is also possible to assess effects of degradations by way of measurement systems which evaluate current, voltage, and/or temperature of the connection system. However, such solutions are linked to significant effort and costs.

An electrical connector element is known from DE 20 2021 004 014 U1, which is used in high-voltage grids of facilities which have to be maintained at certain time intervals. The electrical connector element has at least one heat-conducting component which has a surface area visible in a contact position of electrical contacts participating in the electrical connector element. The surface area is formed by an irreversibly thermochromic material, which displays an irreversible color change as soon as a threshold temperature is exceeded. This design has the disadvantage that the surface area is exposed at all times, so that the surface area is also subjected to the environmental influences which can result in the degradation of the electrical connector element.

It is the object of the invention to provide an electrical connection element, the status of which can be checked easily and reliably.

The object is achieved according to the invention by an electrical connection element in a vehicle, wherein the electrical connection element comprises a first electrical contact and a second electrical contact which are electrically conductively connected inside a connection housing of the electrical connection element. The connection housing has a housing component which is thermally coupled with the first electrical contact and the second electrical contact and comprises an indicator element made of an irreversibly thermochromic material. The housing component is arranged in such a way that the indicator element is not visible in a usage state of the electrical connection element and is visible in a maintenance state of the electrical connection element.

The indicator element enables conclusions to be drawn in a simple manner about the state of the electrical connection element via the color state of the irreversibly thermochromic material.

An irreversibly thermochromic material is a material which displays a color change upon exceeding a material-specific threshold temperature (also referred to as the “switching temperature”), which cannot be reversed even if the temperature sinks back below the threshold temperature. In this way, it can be established easily and reliably even after exceeding the threshold temperature once, for example, in driving operation of the vehicle, at a later point in time, for example, during a maintenance of the vehicle, whether the threshold temperature has already been exceeded at an arbitrary time in the past and thus a failure of the electrical connection element threatens. In this case, the electrical connection element can be exchanged proactively, even before the actual failure, in order to ensure the functionality of the vehicle.

The threshold temperature is selected according to the invention in such a way that it is below a critical failure temperature, at which the electrical connection element is no longer functional to a sufficient extent.

If the connection housing is made of a plastic, for example, which no longer has the required mechanical properties at a critical failure temperature of 150° C., the threshold temperature can be 140° C. or less, for example, 120° C.

The required temperature difference between threshold temperature and critical failure temperature is directed in particular according to whether the respective component suddenly fails upon reaching the critical failure temperature or only gradually worsens.

Irreversibly thermochromic materials are producible, for example, by the use of irreversibly thermochromic pigments, which are generally known and available worldwide. Such pigments are available having various threshold temperatures and color changes, so that with little effort the desired temperature behavior is settable for the intended usage location.

It is moreover provided according to the invention that the indicator element of the housing component is not visible in the usage state of the electrical connection element, thus, for example, in driving operation of the vehicle, but is visible in a maintenance state. In this way, the indicator element can be arranged in the usage state such that it is at least partially protected from direct environmental influences. This is important in particular in electrical connection elements which are arranged in the vicinity of heat-developing components and/or liquid lines of the vehicle, for example, in the engine compartment or in the vicinity of a drive battery. The reliability of the information available by way of the indicator element on the state of the electrical connection element is thus increased, since faults due to degradation effects on the indicator element itself can be avoided or at least reduced.

According to the invention, the electrical connection element can also be part of a charging connection of the vehicle, wherein the first electrical contact or the second electrical contact is assigned to a charging column which is connectable to the vehicle via the charging connection. In this meaning, the respective electrical contact assigned to the charging column is not part of the vehicle as such, but rather is solely temporarily connected to the vehicle, for example, during a charging process. Such charging connections have a special need for being able to be monitored easily, since they are subjected to environmental influences such as rain and soiling to a significant extent.

The indicator element is arranged according to the invention in such a way that it is thermally coupled with the first electrical contact and the second electrical contact as part of the housing component. Excess heat development at the electrical contacts of the electrical connection element thus acts directly on the indicator element.

In one variant, the indicator element is a testing pin, which is arranged in the connector housing in a nondestructively detachable matter. In the maintenance state of the electrical connection element, the testing pin can be removed and visually inspected to check the state of the electrical connection element.

It is moreover possible that the testing pin is part of a locking mechanism of the connection housing, so that the testing pin also acts as a mechanical fastener at the same time, in addition to the function as a state indicator.

In a further variant, the indicator element is an indicator surface which is concealed by a cover, in particular completely concealed, in the usage state of the electrical connection element. In this variant, the cover is removable, in particular nondestructively removable, in the maintenance state of the electrical connection element, or the cover can be transferred into a release position in which the indicator surface is optically visible.

For example, the cover is connected via a hinge to the connection housing, so that the cover is transferable via a rotational movement into the release position and releases the indicator surface.

The indicator surface can be an integral part of the connection housing, for example, in that the irreversibly thermochromic material in the corresponding part of the connection housing forms the material of the connection housing.

It is also possible that the indicator surface is applied later to the connection housing, for example, adhesively bonded, vapor deposited, or sprayed on.

The electrical connection element can be a plug connector and the connection housing can have a first housing portion assigned to the first electrical contact and a second housing portion assigned to the second electrical contact.

The first housing portion and the second housing portion are in particular detachable from one another nondestructively.

In plug connectors, degradation effects are to be attributed in particular to relative movements of the electrical contacts participating in the plug connection, relaxation of the tension force between the participating electrical contacts, and electrically insulating layers, such as oxides, on the participating electrical contacts. Moreover, no arbitrary mechanical means can be provided in plug connectors to counteract degradation mechanisms, since a plug connector has a maximum permissible plugging force in order to be able to be installed so it is detachable nondestructively. However, plug connectors can also be monitored easily and reliably by the use of the display element according to the invention, so that other complex protective mechanisms from degradation effects can be omitted. This is advantageous in particular because in a vehicle a large number of plug connectors are used, the state of which has to be monitored.

Moreover, such a design is suitable for the case that the electrical connection element is part of a charging connection of the vehicle.

The display element can be a housing section of the first housing portion and/or the second housing portion. The housing section is concealed in the usage state of the electrical connection element in this case, for example, by the respective other housing portion.

In an alternative variant, the electrical connection element is crimped and/or ultrasonically welded. In other words, the electrical connection element can be designed in such a way that the first electrical contact and the second electrical contact are not detachable nondestructively. In this way, electrical connection elements which can be especially mechanically loaded can be obtained, the state of which is checkable by means of the indicator element.

To obtain a redundant statement on the behavior of the electrical connection element, in addition to the indicator element, which is not visible in the usage state of the electrical connection element, an additional means can be provided which supplies information on the state of the electrical connection element.

For example, the first electrical contact and/or the second electrical contact can be electrically conductively connected to a lead, which is encased using an insulating coating. wherein the insulating coating comprises a thermochromic material or is made of a thermochromic material.

It has been recognized that a strengthened heat development at the electrical contacts of the electrical connection element can also have the result, due to the typically high thermal conductivity of such electrical contacts, that components connected to the electrical contacts are heated. It is therefore also possible to monitor the state of the electrical connection element on the basis of the temperature development at these connected components. Thermochromic materials can also be used for this purpose in order to permit the state to be optically checked in a simple manner.

In particular, a two-step checking method results in this way, in which a first assessment is obtained via the color of the insulating coating of the lead, which can also be optically accessible at any time, as to whether the electrical connection element is already so strongly degraded that it should be replaced. If this is the case, the indicator element, which is only optically accessible in the maintenance state, can be checked to obtain a second assessment.

It is also possible that the electrical connection element comprises a grommet or a seal in which the connection housing is at least partially received, wherein the grommet or the seal comprises a thermochromic material or is made of a thermochromic material. Analogously to the insulating coating, a two-step checking mechanism of the state of the electrical connection element results in this way.

In still a further variant, a carrier or a housing of a busbar, to which the electrical connection element is electrically connected, comprises a thermochromic material, so that a first indication of the state of the electrical connection element is possible via the color behavior of the busbar.

The electrical connection element is preferably part of a direct-current network of the vehicle. In other words, the electrical connection element is suitable in particular for use in a direct-current network of a vehicle, for example, in a 12 V onboard network of the vehicle.

In particular in the case that the electrical connection element is a part of a charging connection of the vehicle, the electrical connection element can be both part of a direct-current network and part of an alternating current network, so that the charging connection can be configured both for charging processes using direct current and for charging processes using alternating current.

Further features and properties of the invention result from the following description of exemplary embodiments, which are not to be understood in a restrictive sense, and from the figures.

### BRIEF DESCRIPTION OF THE DRAWINGS

FIG. 1 schematically shows a first embodiment of an electrical connection element having an indicator element before a threshold temperature of the indicator element has been reached:

FIG. 2 shows the electrical connection element from FIG. 1 after the threshold temperature of the indicator element has been exceeded:

FIG. 3 schematically shows a second embodiment of the electrical connection element before the threshold temperature of the indicator element has been reached;

FIG. 4 shows the electrical connection element from FIG. 3 after the threshold temperature of the indicator element has been exceeded:

FIG. 5 schematically shows a third embodiment of the electrical connection element before the threshold temperature of the indicator element has been reached;

FIG. 6 shows the electrical connection element from FIG. 5 after the threshold temperature of the indicator element has been exceeded;

FIG. 7 schematically shows a further embodiment of the electrical connection element before the threshold temperature of the indicator element has been reached;

FIG. 8 shows the electrical connection element from FIG. 7 after the threshold temperature of the indicator element has been exceeded;

FIG. 9 schematically shows a fourth embodiment of the electrical connection element before the threshold temperature of the indicator element has been reached; and

FIG. 10 shows the electrical connection element from FIG. 9 after the threshold temperature of the indicator element has been exceeded.

### DETAILED DESCRIPTION OF THE DRAWINGS

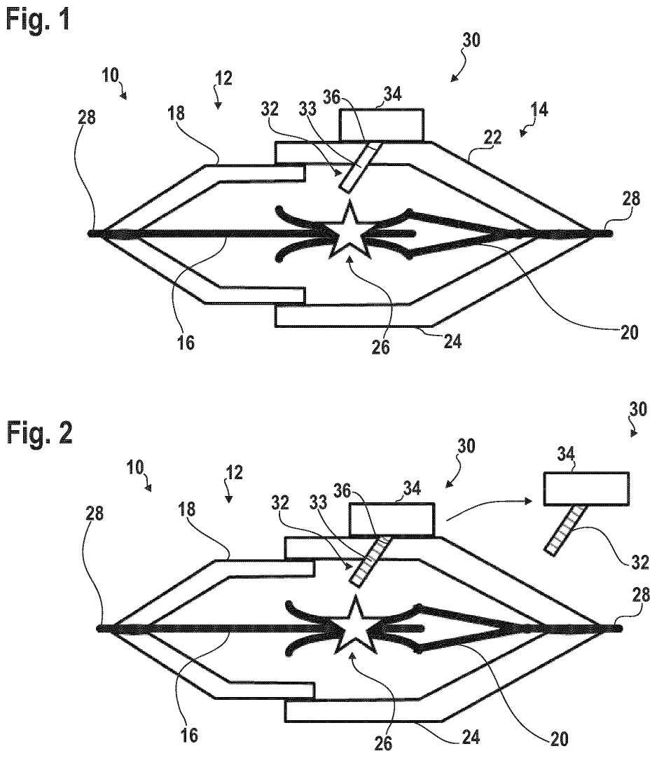

FIG. 1 shows a schematic sectional view of a first embodiment of an electrical connection element 10 according to the invention in a vehicle (not shown in more detail). The vehicle is, for example, an at least partially electrically driven vehicle.

The electrical connection element 10 is a plug connector which is composed of two plug connector halves 12 and 14 connected to one another.

The plug connector half 12 is defined by a first electrical contact 16, to which a first housing portion 18 is assigned, while the plug connector half 14 is defined by a second electrical contact 20, to which a second housing portion 22 is assigned.

The first housing portion 18 and the second housing portion 22 together form a connection housing 24.

FIG. 1 shows the electrical connection element 10 in a usage state, in which the first electrical contact 16 engages in the second electrical contact 20 in such a way that the two electrical contacts 16 and 20 are electrically connected to one another via a contacting point 26 (schematically indicated in the figures by means of a star).

In the embodiment shown, the first electrical contact 16 is designed for this purpose as a blade and the second electrical contact 20 is designed as a bushing complementary to the blade. It is apparent that other types of the contacting point 26 and designs of the electrical contacts 16 and 20 are also possible.

The electrical contacts 16 and 20 are electrically connected via line ends 28 to further components of an electrical line network of the vehicle, which will not be discussed in more detail here. For example, it is a 12 V onboard network of the vehicle.

The connection housing 24 has, according to the invention, a housing component 30, which is thermally coupled with the first electrical contact 16 and the second electrical contact 20. For example, the housing component 30 is arranged in such a way that heat arising at the contacting point 26 can be emitted at least indirectly at the housing component 30.

As can be seen in FIG. 1, the housing component 30 comprises an indicator element 32, which is designed in the first embodiment as a testing pin 33.

The testing pin 33 is connected to a handle element 34 and is inserted in a nondestructively detachable manner into a recess 36, which extends through the connection housing 24, namely through the second housing portion 22.

The testing pin 33 thus protrudes into an interior of the connection housing 24 and ends in the area of the contacting point 26, but without touching it. In this way, due to the atmosphere prevailing inside the connection housing 24, a heat transfer from the contacting point 26 to the testing pin 33 is enabled.

The indicator element 32, thus the testing pin 33, is therefore not externally visible as long as the electrical connection element 10 is in the usage state, but is subjected to the heat which develops at the contacting point 26.

The testing pin 33 comprises an irreversibly thermochromic material, so that the color of the testing pin 33 changes from a starting color, such as white, to a warning color, such as red, if the testing pin 33 heats up above a threshold temperature.

The threshold temperature is selected so that it is reached as soon as a sufficient amount of heat arises at the contacting point 26 such that this can be interpreted as an indicator for an impending failure of the electrical connection element 10. Conclusions about the state of the electrical contacting point 26 or the participating electrical contacts 16 and 20 can therefore be reliably obtained via the color of the display element 32—in a timely manner before the failure occurs.

It is apparent that the color change does not have to take place suddenly. It is also possible that a first partial area of the testing pin 33 already shows a color change, while a second partial area of the testing pin 33 is not yet subject to a color change.

FIG. 2 shows the electrical connection element 10 after the threshold temperature has been reached. It can be seen that the testing pin 33 has colored, as indicated by the shading in FIG. 2.

In a maintenance state of the electrical connection element 10, for example, during a planned inspection of the vehicle, the testing pin 33 can be removed by means of the handle element 34 and optically inspected, as indicated by an arrow in FIG. 2.

Because the testing pin 33 is covered to the outside in the usage state of the electrical connection element 10, the testing pin 33 is protected from environmental influences, for example, from soiling and moisture, as well as temperature influences induced by components of the vehicle outside the electrical connection element 10. In this way, the indicator element 32 according to the invention enables a particularly reliable statement on the state of the electrical connection element 10.

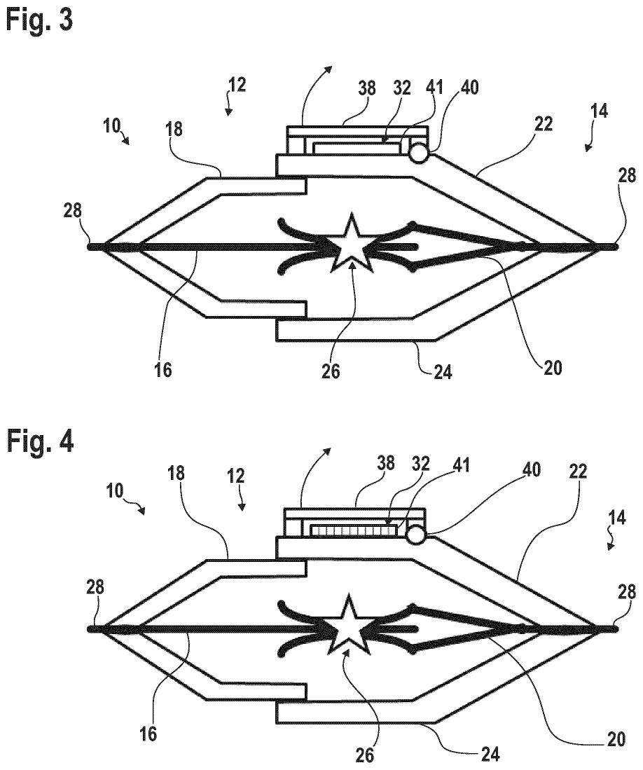

FIG. 3 shows a second embodiment of the electrical connection element 10 according to the invention.

The second embodiment substantially corresponds to the first embodiment, so that only differences are discussed hereinafter. Identical or functionally-identical components are provided with identical reference signs and reference is made to the above statements.

In the second embodiment, the housing component 30 comprises a cover 38, which is connected via a hinge 40 to the connection housing 24, namely to the second housing portion 22.

The cover 38 can therefore be adjusted in a rotational movement from the starting position shown in FIG. 3 into a release position, as indicated by an arrow.

In the second embodiment, the indicator element 32 is designed as an indicator surface 41, which is arranged between the cover 38 and the second housing portion 22.

The indicator surface 41 is, for example, adhesively bonded, vapor deposited, or sprayed on the second housing portion 22.

In the usage state of the electrical connection element 10, the indicator surface 41 is concealed by the cover 38 and protected from environmental influences, while the maintenance state can be achieved easily by adjusting the cover 38 into the release position and the indicator surface 41 can be checked.

FIG. 4 shows the electrical connection element 10 of the second embodiment after the threshold temperature of the indicator element 32, thus the indicator surface 41, has been reached.

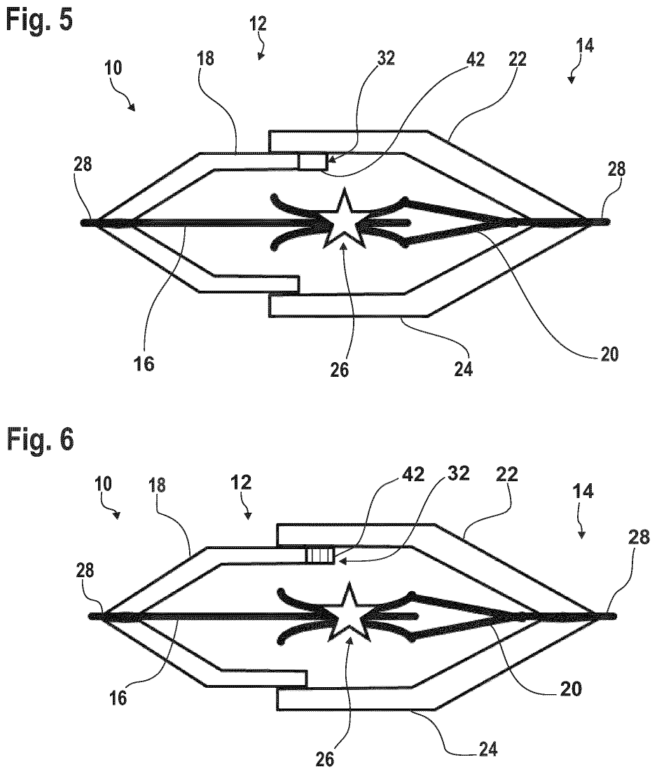

FIG. 5 shows a third embodiment of the electrical connection element 10 according to the invention.

The third embodiment substantially corresponds to the preceding embodiments, so that only differences are discussed hereinafter. Identical or functionally-identical components are provided with identical reference signs and reference is made to the above statements.

In the third embodiment, the indicator element 32 is designed as a housing section 42 of the first housing portion 18. In other words, the indicator element 32 is an integral component of the first housing portion 18, wherein the first housing portion 18 is made of an irreversibly thermochromic material in the part which forms the housing section 42.

The housing section 42 is arranged in this case in such a way that it is not externally visible in the usage state of the electrical connection element 10. In the variant shown in FIG. 5, this is achieved in that the first housing portion 18 has a smaller outside diameter than the second housing portion 22 and the first housing portion 18 is inserted into the second housing portion 22, wherein the housing section 42 is completely accommodated by the second housing portion 22.

In the illustrated variant, the housing section 42 is only arranged at the upper end of the first housing portion 18 shown in FIG. 5. It is apparent that the housing section 42 can also be shaped differently, for example, forms a circumferential area of the first housing portion 18.

FIG. 6 shows the state of the third embodiment after the threshold temperature of the housing section 42 has been reached, i.e., after the irreversible color change of the thermochromic material has occurred.

The two housing portions 18 and 22 can be nondestructively detached from one another in the maintenance state, so that the housing section 42 can be inspected.

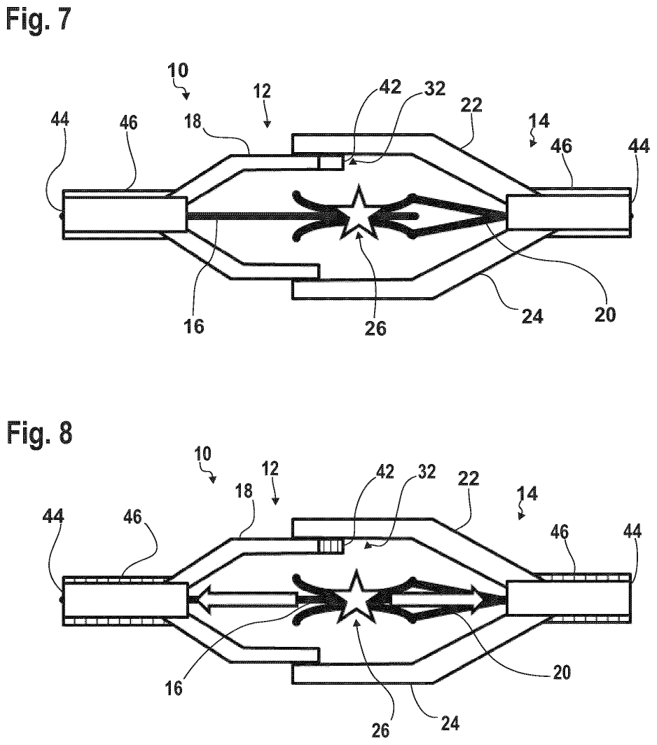

FIG. 7 shows a fourth embodiment of the electrical connection element 10 according to the invention.

The fourth embodiment substantially corresponds to the preceding embodiments, so that only differences are discussed hereinafter. Identical or functionally-identical components are provided with identical reference signs and reference is made to the above statements.

In the fourth embodiment, both the first electrical contact 16 and the second electrical contact 20 are each electrically conductively connected to a lead 44, in particular by means of a crimped connection.

Each of the leads 44 has an insulating coating 46, which electrically insulates the respective lead 44, wherein the insulating coating 46 is or comprises an irreversible thermochromic material.

Accordingly, the electrical connection element 10 according to the fourth embodiment has two different components which can indicate a degradation of the electrical contacting point 26: On the one hand, the indicator element 32, which is designed in the variant shown analogously to the third embodiment as a housing section 42, and, on the other hand, the insulating coating 46.

As can be seen in FIG. 8, which shows the state of the electrical connection element 10 after reaching the threshold temperature, the leads 44 and therefore the insulating coatings 46 are thermally coupled to the respective assigned electrical contact 16 or 20, as schematically illustrated on the basis of arrows.

An elevated temperature development at the contacting point 26 therefore not only has the result that the indicator element 32 is heated, but also the insulating coatings 46. It is thus possible that it is indicated by triggering of the irreversible color change of the insulating coating 46 that the electrical connection element 10 is transferred into the maintenance state and the indicator element 32, which is better shielded from environmental influences than the insulating coatings 46, should be checked.

The threshold temperatures of the indicator element 32 and the insulating coatings 46 can be different to be adapted to the different distance from the contacting point 26.

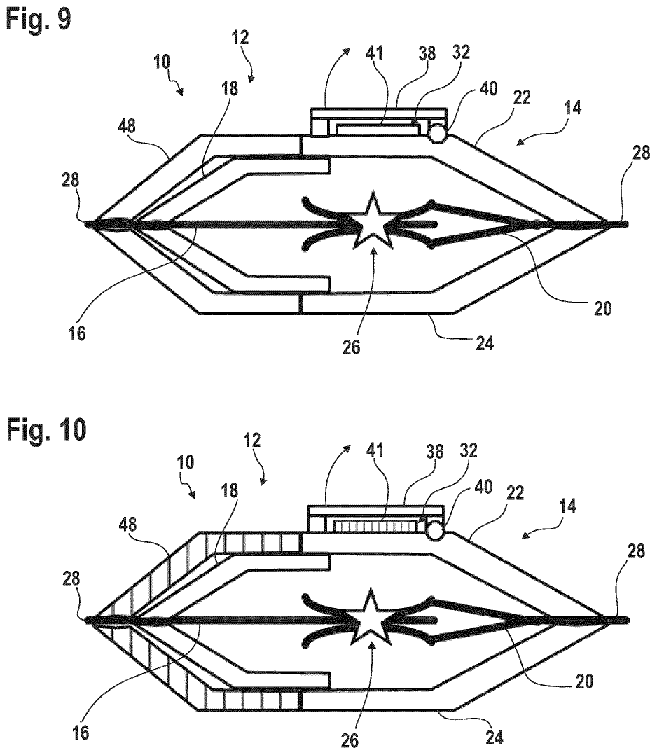

FIG. 9 shows a fifth embodiment of the electrical connection element 10 according to the invention.

The fifth embodiment substantially corresponds to the preceding embodiments, so that only differences are discussed hereinafter. Identical or functionally-identical components are provided with identical reference signs and reference is made to the above statements.

In the fifth embodiment, the first housing portion 18 is accommodated in a grommet 48, which is made of or comprises an irreversibly thermochromic material.

It is apparent that the second housing portion 22 could also have a grommet 48 or the entire connection housing 24 can be enclosed by a grommet 48.

A seal (not shown) can also be used analogously to the grommet 48.

In the fifth embodiment, similarly to the fourth embodiment, a double mechanism is provided for assessing the state of the electrical connection element 10: Both the indicator element 32 (designed in the illustrated variant as an indicator surface 41 analogously to the second embodiment) and also the grommet 48 are thermally coupled with the contacting point 26 and display an irreversible color change as soon as the respective threshold temperature is reached, wherein the threshold temperature of the grommet 48 can differ from that of the indicator surface 41.

If a color change is established on the basis of the grommet 48, as indicated in FIG. 10, the cover 38 can be transferred into the release position and it can be checked on the basis of the indicator surface 41 whether the electrical connection element 10 should be replaced.

The grommet 48 ensures at the same time that the first housing portion 18 is protected from environmental influences.

Overall, the electrical connection element 10 according to the invention is distinguished by a simple and reliable possibility for being able to assess the state of the electrical contacting point 26, so that an exchange of the electrical connection element 10 can be performed before a failure occurs.

1.-10. (canceled)

11. An electrical connection element in a vehicle, comprising:
a connection housing of the electrical connection element;
a first electrical contact and a second electrical contact, which are electrically conductively connected inside the connection housing of the electrical connection element, wherein
the connection housing comprises a housing component thermally coupled with the first electrical contact and the second electrical contact and includes an indicator element made of an irreversibly thermochromic material, and
the housing component is arranged such that the indicator element is not visible in a usage state of the electrical connection element and is visible in a maintenance state of the electrical connection element.

12. The electrical connection element according to claim 11, wherein
the indicator element is a testing pin, which is arranged in a nondestructively detachable manner in the connection housing.

13. The electrical connection element according to claim 11, wherein
the indicator element is an indicator surface, which is concealed by a cover in the usage state of the electrical connection element.

14. The electrical connection element according to claim 13, wherein the cover is connected via a hinge to the connection housing.

15. The electrical connection element according to claim 11, wherein
the electrical connection element is a plug connector, and
the connection housing has a first housing portion assigned to the first electrical contact and a second housing portion assigned to the second electrical contact.

16. The electrical connection element according to claim 15, wherein
the indicator element is a housing section of the first housing portion and/or the second housing portion.

17. The electrical connection element according to claim 11, wherein the electrical connection element is crimped and/or ultrasonically welded.

18. The electrical connection element according to claim 11, wherein
the first electrical contact and/or the second electrical contact is electrically conductively connected to a lead, which lead is encased using an insulating coating, and
the insulating coating comprises a thermochromic material or is made of a thermochromic material.

19. The electrical connection element according to claim 11, wherein
the electrical connection element comprises a grommet or a seal, in which the connection housing is at least partially accommodated, and
the grommet or the seal comprises a thermochromic material or is made of a thermochromic material.

20. The electrical connection element according to claim 11, wherein the electrical connection element is part of a direct-current network of the vehicle.
